(19) United States
(12) Patent Application Publication
(10) Pub. No.: US 2007/0096500 A1
(43) Pub. Date: May 3, 2007

(54) Hard top convertible roof

(76) Inventors: George A. Corder, Romulus, MI (US); Christopher C. Dowdey, Grosse Ile, MI (US); Chris P. Theodore, Birmingham, MI (US); Bradley R. Garska, Saline, MI (US)

Correspondence Address: HARNESS, DICKEY & PIERCE, P.L.C., P.O. BOX 828, BLOOMFIELD HILLS, MI, 48303, US

(21) Appl. No.: 11/590,254

(22) Filed: Oct. 30, 2006

Related U.S. Application Data
(60) Provisional application No. 60/731,305, filed on Oct. 28, 2005.

(51) Int. Cl. B60J 7/08

(52) U.S. Cl. 296/121

(57) ABSTRACT

A convertible top vehicle according to the present invention advantageously utilizes a portion of the rear seating area of the vehicle to stow the roof when in the retracted position. When the convertible top is in the raised position, the rear passenger seating area is not impeded such that both the front and rear seating areas may be utilized.

### CROSS-REFERENCE TO RELATED APPLICATIONS

This application claims the benefit of U.S. Provisional Application No. 60/731,305, filed on Oct. 28, 2005. The disclosure of the above application is incorporated herein by reference.

### FIELD OF THE INVENTION

The present invention relates to vehicles and, more particularly to vehicles having a hard top convertible roof.

### BACKGROUND AND SUMMARY OF THE INVENTION

Vehicles having a convertible roof provide a pleasurable driving experience. A hard top retractable roof (convertible top) using rigid panels may provide a finished appearance that resembles a non-convertible top version of the same vehicle. Additionally, the use of hard top panels may provide a more refined or polished image relative to the use of a soft top convertible roof. Additionally, the hard top panels may have the same appearance or finish as the other body panels of the vehicle.

The stowage space in a vehicle for stowing the convertible roof in a retracted position, however, may be limited. This limited space may inhibit or prevent the use of rigid panels for the convertible roof. Thus, it would be advantageous to facilitate the packaging of the convertible roof in the vehicle such that rigid panels may be utilized. Additionally, it would be advantageous if the packaging space required for the rigid panels is reduced.

A convertible top according to the present invention can advantageously utilize a portion of the rear seating area of the vehicle to stow the panels when in the retracted position. When the convertible top is in the raised position, the rear passenger seating area is not impeded such that both the front and rear seating areas may be utilized. One of the panels can form a cover for the convertible top when in the retracted position. This ability allows the convertible top to advantageously be self-covering. The initial movement of the rearmost panel can be a dropping motion toward the rear passenger seating area. The initial movement can advantageously avoid the use of a moveable tonneau cover on the vehicle. The movement of a rearmost panel and a forward panel can occur simultaneously. The simultaneous movement can speed up the raising and retracting process. A fixed length link can be utilized to guide the movement of a forward panel during movement of the rearmost panel. The fixed length link can advantageously simply the actuation of the roof panels between the raised and retracted positions. The rearmost panel can be moved to a generally vertical position during the raising and retracting process. The generally vertical position can advantageously allow for a large operating window for the convertible top without encroaching undesirably into a front passenger seating area.

Further areas of applicability of the present teachings will become apparent from the detailed description provided hereinafter. It should be understood that the detailed description and specific examples are intended for purposes of illustration only and are not intended to limit the scope of the present teachings.

### BRIEF DESCRIPTION OF THE DRAWINGS

The present invention will become more fully understood from the detailed description and the accompanying drawings, wherein:

FIG. 1 is a side view of a vehicle having a hard top convertible roof according to the present teachings, the convertible roof being in the raised position;

FIG. 2 is a fragmented side view of the vehicle of FIG. 1 in a stage of the retraction process wherein the tonneau cover is in an open position;

FIGS. 3 and 4 are fragmented side views of the vehicle of FIG. 1 with the convertible roof in intermediate positions between the raised and stowed positions;

FIG. 5 is a fragmented side view of the vehicle of FIG. 1 with the convertible roof in the stowed position;

FIG. 6 is a fragmented side view of a vehicle having another hard top convertible roof according to the present teachings, the convertible roof being in the raised position;

FIGS. 7 and 8 are fragmented side views of the vehicle of FIG. 6 with the convertible roof in intermediate positions between the raised and stowed positions;

FIG. 9 is a fragmented side view of the vehicle of FIG. 6 with the convertible roof in the stowed position;

FIG. 10 is a fragmented side view of an alternate linkage arrangement for a portion of the hard top convertible roof of FIGS. 6-9 according to the present teachings;

FIG. 11 is a fragmented side view of a vehicle having yet another hard top convertible roof according to the present teachings, the convertible roof being in the raised position;

FIGS. 12 and 13 are fragmented side views of the vehicle of FIG. 11 with the convertible roof in intermediate positions between the raised and stowed positions;

FIG. 14 is a fragmented side view of the vehicle of FIG. 11 with the convertible roof in the stowed position;

FIG. 15 is a fragmented side view of an alternate linkage arrangement for a portion of the hard top convertible roof of FIGS. 11-14 according to the present teachings;

FIG. 16 is a fragmented side view of a vehicle having still another hard top convertible roof according to the present teachings, the convertible roof being in the raised position;

FIGS. 17 and 18 are fragmented side views of the vehicle of FIG. 16 with the convertible roof in intermediate positions between the raised and stowed positions; and

FIG. 19 is a fragmented side view of the vehicle of FIG. 16 with the convertible roof in the stowed position.

### DETAILED DESCRIPTION

The following description is merely exemplary in nature and is in no way intended to limit the invention, its application, or uses.

In describing the present teaching, the terms “fore” and “aft”, “front” and “back”, “clockwise” and “counterclockwise”, and “forward” and “rearward” may be used to describe the relative movement and components of the present teachings, such usage refers to the orientation of the components when the convertible roof is in the fully raised position and the orientation shown in the views depicted. When describing the various components and linkages of the convertible roofs according to the present teachings, it should be appreciated that the components and linkages are generally symmetrical about a longitudinal, fore-and-aft centerline (not shown) of the vehicle. For brevity, only one side of the convertible roof and the associated linkages may be shown and/or discussed, however, it should be understood that opposite side components and linkages are also provided as part of the convertible roof and are mirror images of the side shown and discussed. Additionally, it should be understood that throughout the drawings and description, corresponding reference numerals (e.g., 20, 120, 220 and 20′, 20″, 20′″) may be used and indicate like or corresponding parts and features.

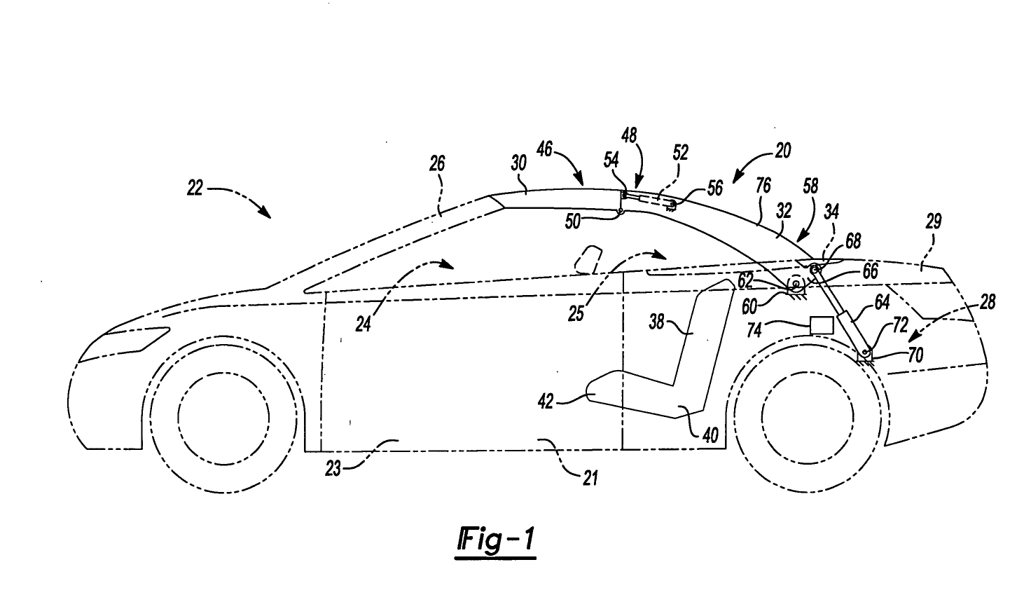

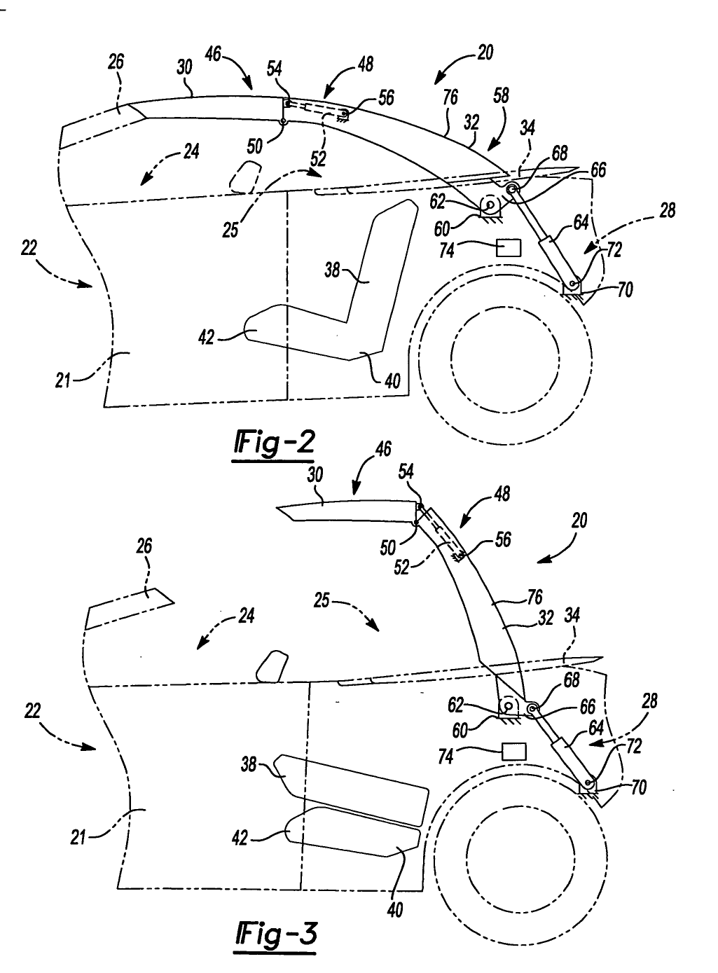

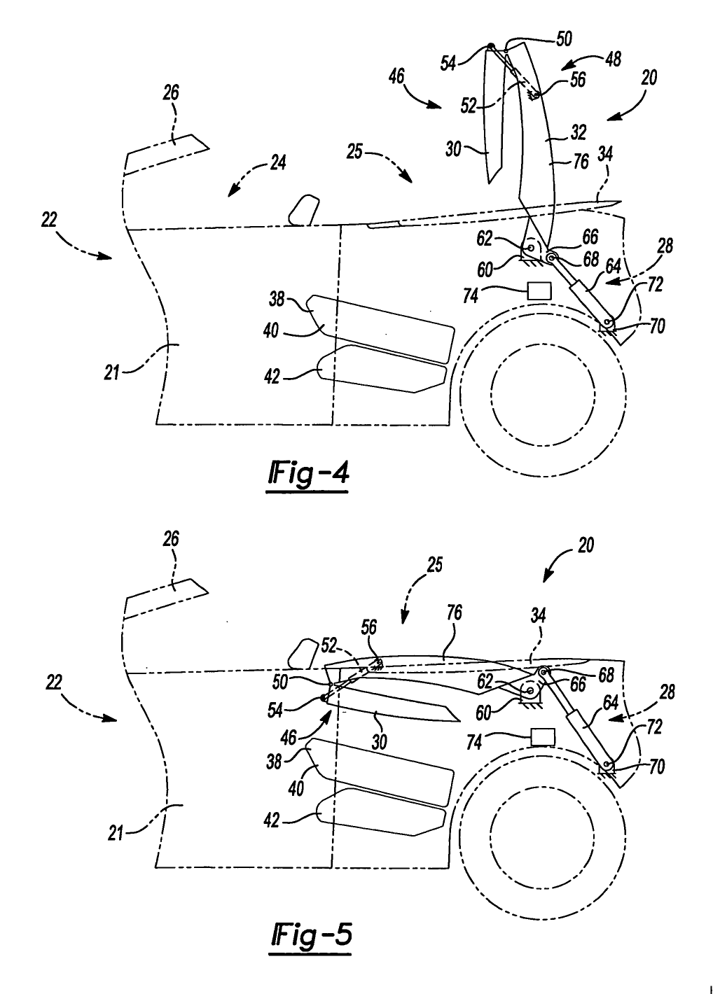

Referring now to FIGS. 1-5, and in particular to FIG. 1, a convertible top (roof) 20 according to the present teachings is shown. Convertible top 20 can be employed on an automotive vehicle 22 having a body 21 and a pair of doors 23 which allow access to both front and rear passenger compartments 24, 25. Vehicle 22 includes a front header 26 that extends along a top portion of the front windshield. Vehicle 22 can have a storage or trunk compartment 28 disposed behind rear passenger compartment 25. A deck lid or trunk lid 29 can allow access to storage compartment 28 from a rear of vehicle 22 regardless of convertible top 20 being a raised or retracted position. Storage compartment 28, if desired, may be separated from rear passenger compartment 25. Convertible top 20 is of the type utilizing a linkage assembly and/or actuator(s) to move a front rigid panel 30 and a rear rigid panel 32 between a raised position, as shown in FIG. 1, through intermediate positions, such as those shown in FIGS. 3-4, to a stowed position, as shown in FIG. 5. A linkage assembly (not shown) can move a rigid tonneau cover 34 between a lowered position, as shown in FIGS. 1 and 5, and a raised position, as shown in FIGS. 2-4. Rear panel 32 can include a rigid back light (not shown) which may be made of various materials, such as glass. A high mount stop light (not shown) may be integrated into tonneau cover 34.

Tonneau cover 34 is independent of deck lid 29 and can be moved between lowered and raised positions to allow retraction and extension of convertible top 20 as described below. Similarly, deck lid 29 can be operated independently of tonneau cover 34 and can move between open and closed positions (not shown) to allow access to storage compartment 28. Alternatively, vehicle 22 can be equipped with a dual acting deck lid (not shown) in place of the separate tonneau cover and deck lid as shown. For example, tonneau cover 34 and deck lid 29 can be replaced by a single two-way opening deck lid that opens in one direction to allow extension and retraction of convertible top 20 and can be opened in an opposite direction to allow access to storage compartment 28 from a rear of vehicle 22. An example of such a two-way acting deck lid is disclosed in U.S. Pat. No. 5,823,606, entitled “Hard-Top Vehicle” issued to Schenk et al., the disclosure of which is incorporated by reference herein.

Still referring to FIGS. 1-5, seatbacks 38 of rear passenger seats 40 can fold forwardly toward bottom cushions 42 from an upright position, as shown in FIGS. 1 and 2, to a stowed position, as shown in FIGS. 3-5, to provide a stowage space within rear passenger compartment 25 for convertible top 20. A biasing mechanism, such as a spring, can be utilized to facilitate folding of seatback 38, if desired. A rear portion 46 of front panel 30 can be pivotally coupled to a front portion 48 of rear panel 32 at pivot 50. Pivot 50 can be a hinge that directly couples front and rear panels 30, 32 together. This coupling of front panel 30 to rear panel 32 enables front and rear panels 30, 32 to retract in a clam-shell manner, as described below. One end of a front actuator 52 can be pivotally coupled to rear portion 46 of front panel 30 at pivot 54 while an opposite end of front actuator 52 can be pivotally coupled to rear panel 32 at pivot 56. Front actuator 52 can extend and retract in response to an input to drive rotation of front panel 30 relative to rear panel 32 about pivot 50. Front actuator 52 can be a fluidic actuator, such as a hydraulic or pneumatic actuator.

A rear portion 58 of rear panel 32 can be pivotally coupled a fixed bracket 60 at pivot 62. This coupling of rear panel 32 to bracket 60 enables rear panel 32 to rotate about pivot 62 and move between the raised and stowed positions, as described below. One end of a rear actuator 64 can be pivotally coupled to an extension 66 of rear panel 32 at pivot 68. An opposite end of actuator 64 can be pivotally coupled to a fixed bracket 70 at pivot 72. Brackets 60 and 70 can be fixed to a rear portion of vehicle 22. Rear actuator 64 can extend and retract in response to an input to drive rotation of rear panel 32 relative to vehicle 22 about pivot 62. Rear actuator 64 can be a fluidic actuator, such as a hydraulic or pneumatic actuator.

The interconnection of front and rear panels 30, 32 and vehicle 22 by the various pivots enables the retraction and extension of convertible top 20 in a controlled manner through the use of a front and rear actuators 52, 64 on each side of convertible top 20 which is controlled by an electronic control unit 74, such as a microprocessor, as described below.

Devices such as limit switches, sensors and/or potentiometers can be coupled to body 21, rear passenger seats 40, tonneau cover 34 and convertible top 20 to inform control unit 74 of the position of tonneau cover 34, rear passenger seats 40, retractable windows, and convertible top 20 (including the position of various linkages) to ensure that convertible top 20, rear passenger seats 40, retractable windows, and tonneau cover 34 do not interfere with one another and that convertible top 20 and actuators 52, 64 are properly controlled to move between stowed and raised positions. An example of a suitable control system for a convertible top 20, tonneau cover 34, retractable windows, and/or rear passenger seats 40 is that disclosed in U.S. Pat. No. 6,288,511 entitled “Automotive Convertible Top System” issued to Porter et al. and assigned to the assignee of the present invention, the disclosure of which is incorporated by reference herein.

In operation, convertible top 20 is moved from the raised position depicted in FIG. 1 through intermediate positions, such as the ones depicted in FIGS. 3 and 4, to the stowed position depicted in FIG. 5 by first unlatching front panel 30 from front header 26. An operator engages a switch (not shown) located in passenger compartment 24. The switch is electrically connected to control unit 74 to control the operation of convertible top 20.

When tonneau cover 34 is controlled by control unit 74, control unit 74 sends a signal causing tonneau cover 34 to move to the appropriate position (in this case move rearwardly and upwardly), as shown in FIG. 2, to allow the desired movement of convertible top 20. If a separate control system (not shown) is used to control operation of tonneau cover 34, the switch can also be electrically connected to the separate control system to cause tonneau cover 34 to move to the appropriate position to allow the desired movement of convertible top 20. When a manually operated tonneau cover 34 is utilized, control unit 74, through the use of proximity switches and/or sensors, detects the position of tonneau cover 34 to ensure it is in the proper position for the desired movement of convertible top 20.

When the folding of seatbacks 38 are controlled by control unit 74, control unit 74 sends a signal causing seatbacks 38 to move to the appropriate position (in this case fold forwardly on top of bottom cushions 42), as shown in FIG. 3-5, to allow the desired movement of convertible top 20. If a separate control system (not shown) is used to control operation of seatbacks 38, the switch can also be electrically connected to the separate control system to cause seatbacks 38 to move to the appropriate position to allow the desired movement of convertible top 20. When a manually operated seatback 38 is utilized, control unit 74, through the use of proximity switches and/or sensors, detects the position of seatbacks 38 to ensure proper positioning for the desired movement of convertible top 20.

When the retractable windows are controlled by control unit 74, control unit 74 sends a signal causing the retractable windows to move to the appropriate position (in this case downwardly into doors 23 and/or body 21) to allow the desired movement of convertible top 20. If a separate control system (not shown) is used to control operation of the retractable windows, the switch can also be electrically connected to the separate control system to cause the retractable windows to move to the appropriate position to allow the desired movement of convertible top 20. When manually operated retractable windows are utilized, control unit 74, through the use of proximity switches and/or sensors, detects the position of the retractable windows to ensure the retractable windows are in the proper position for the desired movement of convertible top 20.

Regardless of the system(s) employed to control tonneau cover 34, seatbacks 38 and the retractable windows, once tonneau cover 34, seatbacks 38 and the retractable windows are in the appropriate positions to allow the desired movement of convertible top 20, control unit 74 sends a signal to operate actuators 52, 64. Control unit 74 causes actuator 64 to begin retracting which drives clockwise rotation of rear panel 32 about fixed pivot 62. Control unit 74 also causes actuator 52 to begin extending which drives counter clockwise rotation of front panel 30 relative to rear panel 32 about pivot 50 in a clam shell type manner. Retraction of actuator 64 continues until rear panel 32 has moved to an appropriate position that allows actuator 52 to drive rotation of front panel 30 about pivot 50 without intruding into front passenger compartment 24. As shown in FIG. 4, rear panel 32 can rotate about pivot 62 to a generally vertical position to allow adequate clearance between a front edge of front panel 30 and front passenger compartment 24. Control unit 74 can cause actuator 64 to hold rear panel 32 in its uprightmost position until front panel 30 has rotated about pivot 50 to the appropriate stowage position relative to rear panel 32, as shown in FIG. 4. Front panel 30 can move to a generally vertical position adjacent rear panel 32 while rear panel 32 is in its generally vertical position. The interior surface of front panel 30 faces the interior surface of rear panel 32 when in the stowed position.

Once front panel 30 has rotated about pivot 50 to its stowed position relative to rear panel 32, control unit 74 can cause actuator 52 to hold front panel 30 in the stowed position and can cause actuator 64 to begin extending and drive counter clockwise rotation of rear panel 32 about pivot 62 such that convertible top 20 rotates forwardly into rear passenger compartment 25, as shown in FIG. 5. Once convertible top 20 is in the fully stowed position, tonneau cover 34 can be moved to its lowered position (in this case moved forwardly and downwardly) and can align with deck lid 29 and a portion of an exterior surface 76 of rear panel 32. To move convertible top 20 from the stowed position to the raised positions, the opposite procedure can be performed.

Thus, in convertible top 20, rear panel 32 undergoes two different phases of motion (a clockwise and a counter clockwise rotation about pivot 62) to move from either the raised or stowed position to the other position. Exterior surface 76 of rear panel 32 can provide an aesthetically pleasing and sculpted appearance for vehicle 22 yielding a sporty aerodynamic look of a roadster. The back light in rear panel 32 can form a part of exterior surface 76. Additionally, exterior surface 76 of rear panel 32 when in the retracted position acts as a cover for the stored convertible top 20. As shown in FIG. 5, the convertible vehicle 22 is thereby converted from a 4-passenger coupe to a 2-passenger roadster by moving convertible top 20 from the raised or operative position to the stowed or retracted position.

Panels 30, 32 can be made from a variety of materials. By way of non-limiting example, panels 30, 32 may be made from a metal, a polymer, a sheet-molded component, glass, and the like. Additionally, if desired, panels 30, 32 may be covered with a pliable fabric or include a sunroof. As such, panels 30, 32 can provide a show surface that matches the vehicle body panels. Additionally, the interior surfaces of the panels may be textured to match an interior of the vehicle.

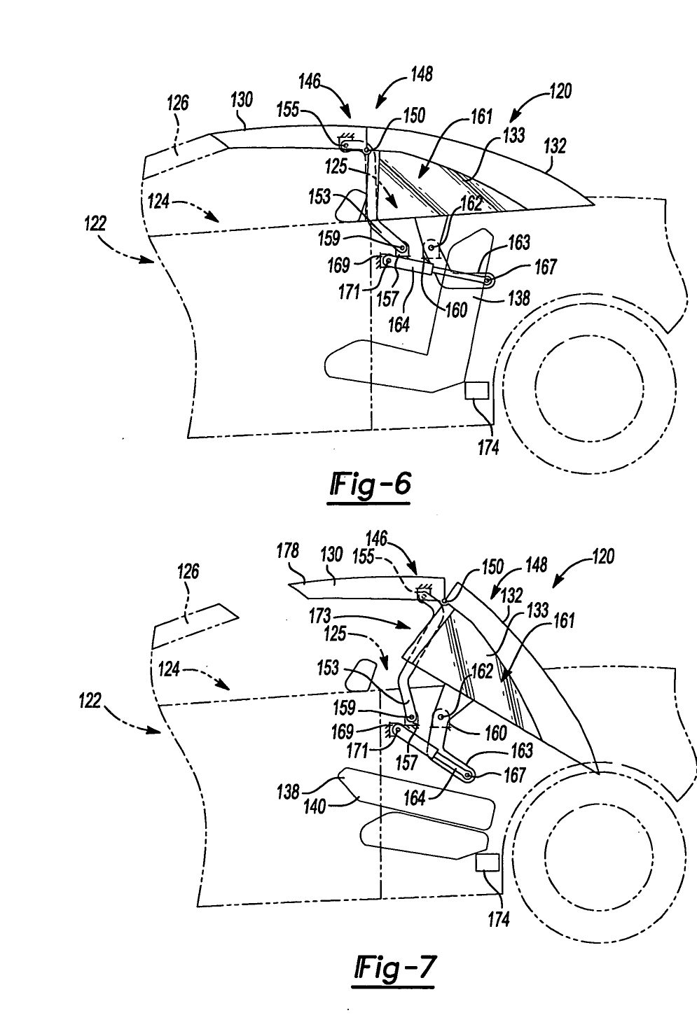

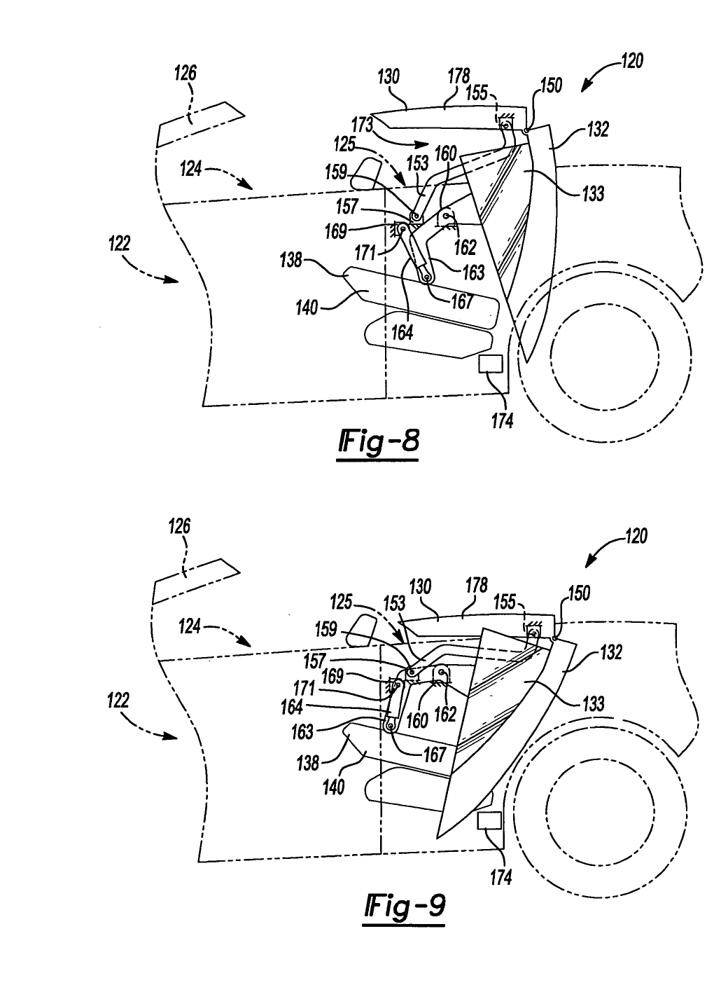

Referring now to FIGS. 6-9, a convertible top 120 according to the present teachings is shown on a vehicle 122. Convertible top 120 and vehicle 122 are similar to convertible top 20 and vehicle 22 discussed above and utilizes linkage assemblies and/or actuator(s) to move a front rigid panel 130 and a rear rigid panel 132 between a raised position, as shown in FIG. 6, through intermediate positions, such as those shown in FIGS. 7 and 8, to a stowed position, as shown in FIG. 9. Due to the similarities between convertible tops 20 and 120 and vehicles 22 and 122, the description of convertible top 120 and vehicle 122 may be limited to the differences with convertible top 20 and vehicle 22 and all of the details of convertible top 120 and vehicle 122 may not be discussed.

A rear portion 146 of front panel 130 can be pivotally coupled to a front portion 148 of rear panel 132 at pivot 150. This coupling of front panel 130 to rear panel 132 enables front and rear panels 130, 132 to retract in a clam-shell manner, as described below. One end of a front link 153 can be pivotally coupled to rear portion 146 of front panel 130 at pivot 155 while an opposite end of front link 153 can be pivotally coupled to a fixed bracket 157 at pivot 159. Front link 153 is fixed in length and constrains movement of front panel 132.

An intermediate portion 161 of rear panel 132 can be pivotally coupled to a fixed bracket 160 at pivot 162. The coupling of rear panel 132 to bracket 160 limits movement of rear panel 132 relative to vehicle 122 to rotational movement about pivot 162 and enables rear panel 132 to move between the raised and stowed positions, as described below. One end of a rear actuator 164 can be pivotally coupled to an arm 163 extending from rear panel 132 at pivot 167 downward and rearward of pivot 162 when rear panel 132 is in the raised position, as shown in FIG. 6. An opposite end of actuator 164 can be pivotally coupled to a fixed bracket 169 at pivot 171. Brackets 157, 160 and 169 can be fixed to a vehicle 122 adjacent rear passenger compartment 125. Rear actuator 164 can extend and retract in response to an input to drive rotation of rear panel 132 relative to vehicle 122 about pivot 162. Rear actuator 164 can be a fluidic actuator, such as a hydraulic or pneumatic actuator.

The interconnection of front and rear panels 130, 132, front link 153 and vehicle 122 forms a four-bar linkage assembly 173 defined by pivots 150, 155, 159 and 162. Four-bar linkage assembly 173 controls motion of front panel 130 relative to rear panel 132 and vehicle 122 during movement of convertible top 120 between the raised and stowed positions. The movement of convertible top 120 is driven extension and retraction of actuators 164 on each side of convertible top 120 which are controlled by control unit 174.

Convertible top 120 utilizes devices such as limit switches, sensors and/or potentiometers which can be coupled to body 121, rear passenger seats 140, retractable windows, and convertible top 120 to inform control unit 174 of the position of rear passenger seats 140, retractable windows, and convertible top 120 (including the position of various linkages) to ensure that convertible top 120, rear passenger seats 140, and retractable windows do not interfere with one another and that convertible top 120 and actuators 164 are properly controlled to move between stowed and raised positions.

In operation, convertible top 120 is moved from the raised position depicted in FIG. 6 through intermediate positions, such as the ones depicted in FIGS. 7 and 8, to the stowed position depicted in FIG. 9 by first unlatching front panel 130 from front header 126. An operator engages a switch (not shown) located in passenger compartment 124. The switch is electrically connected to control unit 174 to control the operation of convertible top 120. The positioning of seatbacks 138 and the retractable windows can be done in the same manner discussed above with reference to operation of convertible top 20. As shown in FIGS. 6-9, rear panel 132 can include fixed quarter panel windows 133 that move with movement of rear panel 132 between the raised and stowed positions. The use of a fixed quarter panel window 133 can avoid the cost associated with providing a separate retraction mechanism for the rear quarter panel window. It should be appreciated, however, that rear panel 132 can be independent of the quarter panel windows 133, in which case the rear quarter windows 133 can be retractable into body 121 of vehicle 122.

Regardless of the system(s) employed to control seatbacks 138 and the retractable windows, once seatbacks 138 and the retractable windows are in the appropriate positions to allow the desired movement of convertible top 120, control unit 174 sends a signal to operate actuator 164. Control unit 174 causes actuator 164 to begin retracting which drives counterclockwise rotation of rear panel 132 about fixed pivot 162. This rotation of rear panel 132 causes rear portion 158 of rear panel 132 to immediately begin falling below the beltline of vehicle 122 and into rear passenger compartment 125. As a result of this movement, the need for a moveable tonneau cover can be avoided. The rotation of rear panel 132 about pivot 162 causes four-bar linkage assembly 173 to move front panel 130 rearwardly and drive counterclockwise rotation of front panel 130 relative to rear panel 132 about pivot 150. Continued extension of actuator 164 causes further rotation of rear panel 132 about pivot 162 and drives front panel toward a generally horizontal orientation above rear passenger compartment 125. Extension of actuator 164 continues until front and rear panels 130, 132 have moved to the stowed position in rear passenger compartment 125, as shown in FIG. 9. Once convertible top 120 is in the fully stowed position, control unit 174 causes actuator to cease extending. To move convertible top 120 from the stowed position to the raised position, the opposite procedure can be performed.

During movement of rear panel 132 between the raised and stowed positions, rear panel 132 can rotate about pivot 162 greater than about 100 degrees. The amount of rotation can vary based on the vehicle architecture upon which convertible top 120 is employed. In the stowed position, the interior surface of rear panel 132 can face generally forwardly. In the stowed position, the exterior surface 178 of front panel 130 can provide an aesthetically pleasing and sculpted appearance for vehicle 22 yielding a sporty aerodynamic look of a roadster. Additionally, exterior surface 178 of front panel 130 when in the retracted position acts as a cover for the stored convertible top 120. As shown in FIG. 9, vehicle 122 is thereby converted from a 4-passenger coupe to a 2-passenger roadster by moving convertible top 120 from the raised or operative position to the stowed or retracted position. The entire motion of convertible top 120 between the raised and stowed positions can be driven by a single pair of actuators 164 that cause rotation of rear panel 132 about pivot 162.

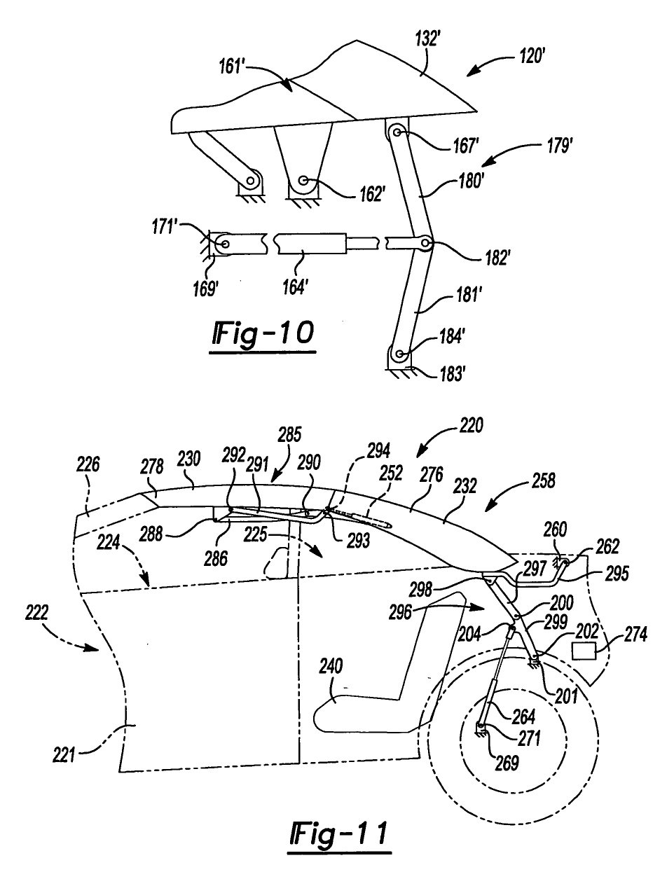

Referring now to FIG. 10, a linkage assembly 179′ for driving rotation of rear panel 132′ of convertible top 120′ about pivot 162′ is shown. Linkage assembly 179′ works in conjunction with rear actuator 164′ and includes a first link 180′ having one end pivotally coupled to intermediate portion 161′ of rear panel 132′ at pivot 167′. An opposite end of first link 180′ is pivotally coupled one end of a second link 181′ at pivot 182′. An opposite end of second link 181′ is pivotally coupled to a fixed bracket 183′ at pivot 184′. One end of rear actuator 164′ is pivotally coupled to first and second links 180′, 181′ at pivot 182′ while and opposite end of rear actuator 164′ is pivotally coupled to a fixed bracket 169′ at pivot 171′. Extension and retraction of actuator 164′ can thereby drive rotation of rear panel 132′ about pivot 162′ and cause convertible top 120′ to move between the raised and stowed positions.

The use of linkage assembly 179′ can facilitate rotation of convertible top 120′. In particular, rotation of rear panel 132′ greater than about 130 to about 135 degrees through a direct drive linear actuator, such as shown in FIGS. 6-9 and associated with convertible top 120, can be difficult. The use of linkage assembly 179′, however, can provide additional rotation for rear panel 132′. Moreover, the use of linkage assembly 179′ can also improve packaging efficiency by providing for a smaller packaging space for the components that drive retraction and extension of convertible top 120′. The use of linkage assembly 179′ can also facilitate the holding of convertible top 120′ in the raised position by driving linkage assembly 179′ into an over-center position to provide a locking function, if desired. Specifically, a stop can be used to limit movement of convertible top 120′ into the fully raised position and linkage assembly 179′ can be configured to take an over-center position when convertible top 120′ is in the fully raised position and engaged with the stop. As a result, the dynamic system of linkage assembly 179′, rear panel 132′ and the stop is driven to ground and becomes a static structure that can take the loading off of actuator 164′.

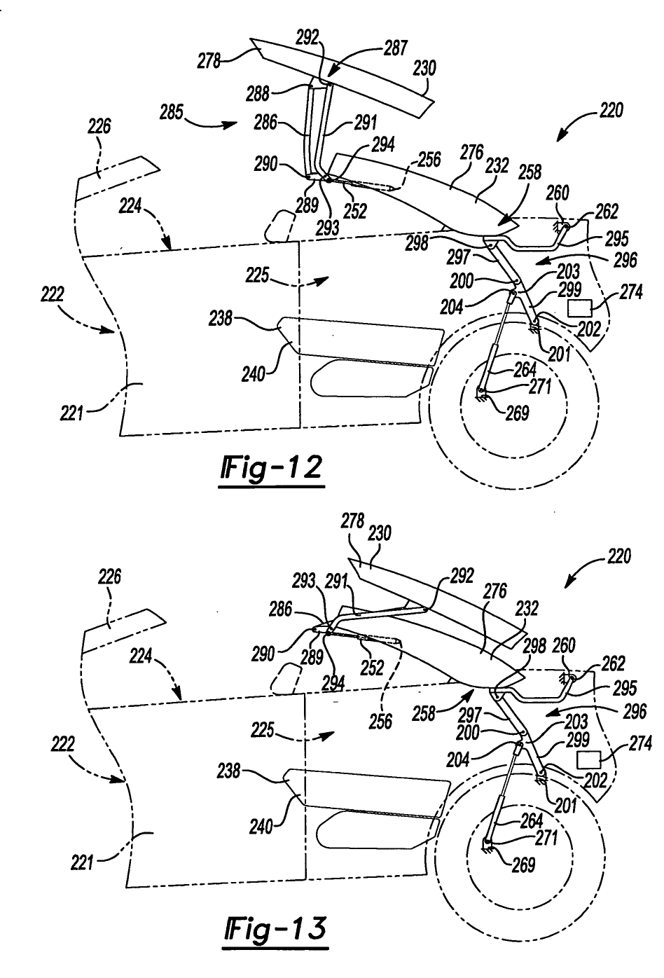

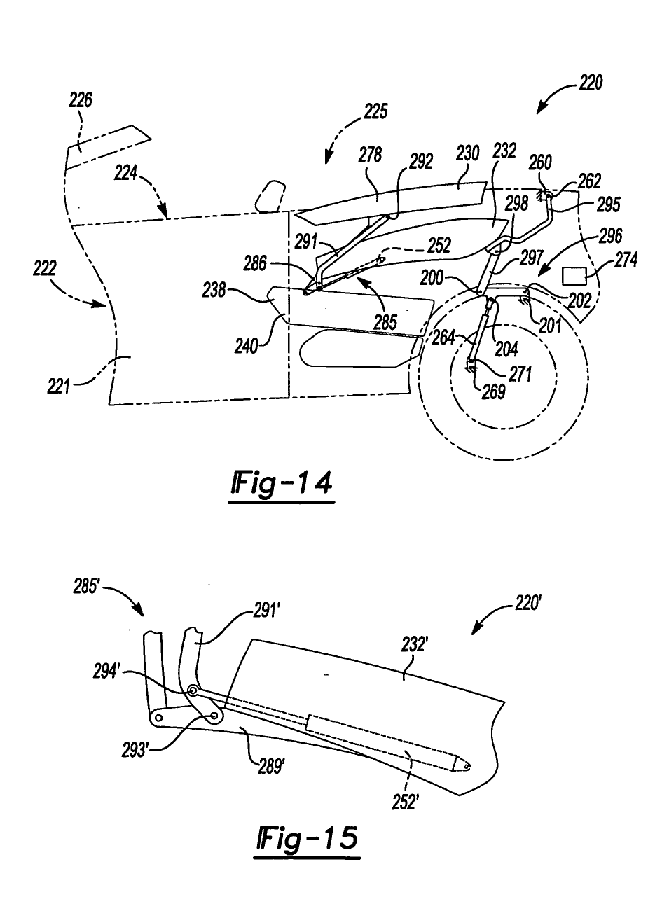

Referring now to FIGS. 11-14, a convertible top 220 according to the present teachings is shown on a vehicle 222. Convertible top 220 and vehicle 222 are similar to convertible top 20 and vehicle 22 discussed above and utilizes linkage assemblies and/or actuator(s) to move a front rigid panel 230 and a rear rigid panel 232 between a raised position, as shown in FIG. 11, through intermediate positions, such as those shown in FIGS. 12 and 13, to a stowed position, as shown in FIG. 14. Due to the similarities between convertible tops 20 and 220 and vehicles 22 and 222, the description of convertible top 220 and vehicle 222 may be limited to the differences with convertible top 20 and vehicle 22 and all of the details of convertible top 220 and vehicle 222 may not be discussed.

In convertible top 220, front panel 230 can be coupled to rear panel 232 with a front four-bar linkage assembly 285. One end of a first link 286 can be pivotally coupled to an intermediate portion 287 of front panel 230 at pivot 288 while an opposite end can be pivotally coupled to a forwardly extending projection 289 of rear panel 232 at pivot 290. One end of a second link 291 can be pivotally coupled to intermediate portion 287 of front panel 230 at pivot 292 while an opposite end portion of second link 291 can be pivotally coupled to projection 289 at pivot 293 rearward of pivot 290. Front panel 230, first link 286, projection 289 and second link 291 thereby form four-bar linkage assembly 285 defined by pivots 288, 290, 293, and 292. Linkage assembly 285 controls motion of front panel 230 relative to rear panel 232 and vehicle 222 during movement of convertible top 220 between the raised and stowed positions. One end of a front actuator 252 can be pivotally coupled to an end of second link 291 at pivot 294 rearward of pivot 293. An opposite end of actuator 252 can be pivotally coupled to rear panel 232 at pivot 256. Front actuator 252 can extend and retract in response to an input to drive movement of front panel 230 relative to rear panel 232 as controlled by linkage assembly 285. Front actuator 252 can be a fluidic actuator, such as a hydraulic or pneumatic actuator.

A rear portion 258 of rear panel 232 can have a rearwardly extending arm 295 that can be pivotally coupled to fixed bracket 260 at pivot 262. The coupling of rear panel 232 to bracket 260 limits movement of rear panel 232 relative to vehicle 222 to rotational motion about pivot 262 and enables rear panel 232 to move between the raised and stowed positions, as described below. A rear linkage assembly 296 can also couple rear panel 232 to vehicle 222. Linkage assembly 296 can include a first link 297 having one end pivotally coupled to rear portion 258 of rear panel 232 at pivot 298 and an opposite end pivotally coupled to an end of a second link 299 at pivot 200. The opposite end of second link 299 can be pivotally coupled to a fixed bracket 201 at pivot 202. One end of a rear actuator 264 can be pivotally coupled to a forwardly extending projection 203 on second link 299 at pivot 204. Pivot 204 can be adjacent pivot 200. An opposite end of actuator 264 can be pivotally coupled to a fixed bracket 269 at pivot 271. Rear actuator 264 can extend and retract in response to an input to cause movement of linkage assembly 296 and drive rotation of rear panel 232 relative to vehicle 222 about pivot 262. Rear actuator 164 can be a fluidic actuator, such as a hydraulic or pneumatic actuator.

The movement of convertible top 220 between the raised and stowed positions is driven by extension and retraction of actuators 252, 264 on each side of convertible top 220. Actuators 252, 264 can be controlled by control unit 274.

Convertible top 220 utilizes devices such as limit switches, sensors and/or potentiometers which can be coupled to body 221, rear passenger seats 240, retractable windows, and convertible top 220 to inform electronic unit 274 of the position of rear passenger seats 240, retractable windows, and convertible top 220 (including the position of various linkages) to ensure that convertible top 220, rear passenger seats 240, and retractable windows do not interfere with one another and that convertible top 220 and actuators 252, 264 are properly controlled to move between stowed and raised positions.

In operation, convertible top 220 is moved from the raised position depicted in FIG. 11 through intermediate positions, such as the ones depicted in FIGS. 12 and 13, to the stowed position depicted in FIG. 14 by first unlatching front panel 230 from front header 226. An operator engages a switch (not shown) located in passenger compartment 224. The switch is electrically connected to control unit 274 to control the operation of convertible top 220. The positioning of seatbacks 238 and the retractable windows can be done in the same manner discussed above with reference to operation of convertible top 20.

Regardless of the system(s) employed to control seatbacks 238 and the retractable windows, once seatbacks 238 and the retractable windows are in the appropriate positions to allow the desired movement of convertible top 220, control unit 274 sends a signal to operate actuators 252, 264. Control unit 274 causes actuator 252 to begin extending which causes linkage assembly 285 to drive movement of front panel 230 relative to rear panel 232. Front panel 230 moves upwardly and rearwardly relative to rear panel 232 as actuator 252 extends. As actuator 252 continues to extend, front panel continues to move rearwardly relative to rear panel 232 and eventually begins to move downwardly relative to rear panel 232 with the interior surface of front panel 230 facing the exterior surface 276 of rear panel 232. Actuator 252 continues to extend until front panel 230 has moved to its stowed position relative to rear panel 232, as shown in FIG. 13. Control unit 274 then causes actuator 252 to maintain front panel 230 stationary relative to rear panel 232.

With front panel 230 in its relative stowed position, control unit 274 causes actuator 264 to begin retracting which drives linkage assembly 296 and pulls rear panel 232 (and relatively stationary front panel 230) downwardly into rear passenger compartment 225 as rear panel 232 rotates counterclockwise about pivot 262. This rotation of rear panel 232 causes rear portion 258 of rear panel 232 to immediately begin falling below the beltline of vehicle 222 and into rear passenger compartment 225. As a result of this movement, the need for a moveable tonneau cover can be avoided. Continued retraction of actuator 264 causes further rotation of rear panel 232 about pivot 262 and continues until rear panel 232 (and front panel 230) has moved to the stowed position in rear passenger compartment 225, as shown in FIG. 14. Once convertible top 220 is in the fully stowed position, control unit 274 causes actuator 264 to cease retracting. To move convertible top 220 from the stowed position to the raised position, the opposite procedure can be performed.

The use of linkage assembly 296 can facilitate the holding of convertible top 220 in the raised position and provide a locking function. Specifically, a stop can be used to limit movement of convertible top 220 into the fully raised position and linkage assembly 296 can be configured to take an over-center position when convertible top 220 is in the fully raised position and engaged with the stop. As a result, the dynamic system of linkage assembly 296, actuator 264, rear panel 232 and the stop is driven to ground and becomes a static structure that can take the loading off of actuator 264. The use of linkage assembly 296 can also facilitate with driving rotation of rear panel 232 about pivot 262. Moreover, linkage assembly 296 may also provide improved packaging efficiency.

In the stowed position, the interior surface of front panel 230 faces the exterior surface 276 of rear panel 232. In the stowed position, the exterior surface 278 of front panel 230 can provide an aesthetically pleasing and sculpted appearance for vehicle 222 yielding a sporty aerodynamic look of a roadster. Additionally, exterior surface 278 of front panel 230 when in the retracted position acts as a cover for the stored convertible top 220. As shown in FIG. 14, the convertible vehicle 222 is thereby converted from a 4-passenger coupe to a 2-passenger roadster by moving convertible top 220 from the raised or operative position to the stowed or retracted position.

If desired, control unit 274 can causes actuators 252 and 264 to operate simultaneously for all or discrete portion(s) of the raising and lowering of convertible top 220. In such a situation, control unit 274 operates actuators 252 and 264 in such a manner as to avoid convertible top 220 from encroaching into front passenger compartment 224.

Referring now to FIG. 15, an alternate arrangement for front linkage assembly 285′ and actuator 252′ for driving movement of the front panel relative to rear panel 232′ of convertible top 220′ is shown. In linkage assembly 285′ the forward end of actuator 252′ is pivotally coupled to an end portion of second link 291′ in front of pivot 293′ which couples the end of second link 291′ to forwardly extending projection 289′ of rear panel 232′. In this arrangement, actuator 252′ retracts (instead of extending as with linkage assembly 285) to cause the front panel to move from the raised position to its stowed position above rear panel 232′. Actuator 252′ will then extend to drive motion of the front panel from its stowed position to the raised position.

The use of linkage assembly 285 or 285′ can be selected for the particular packaging space available. In particular, linkage assemblies 285, 285′ can require different packaging spaces or configurations. These linkage assemblies 285, 285′ can be chosen based upon the packaging space available for the particular vehicle upon which convertible top 220, 220′ is to be employed.

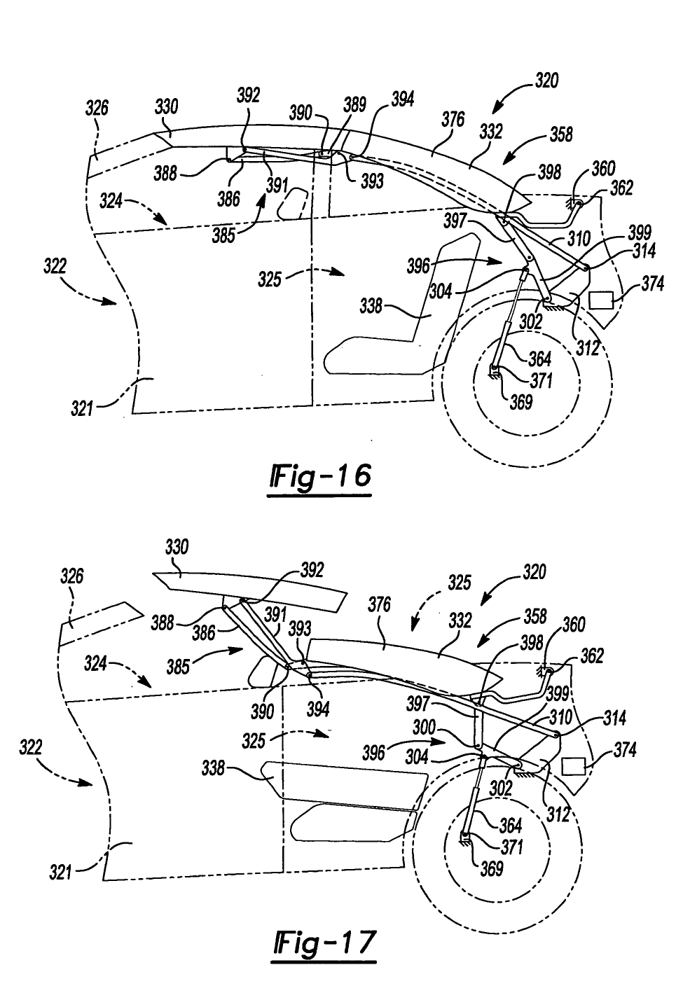

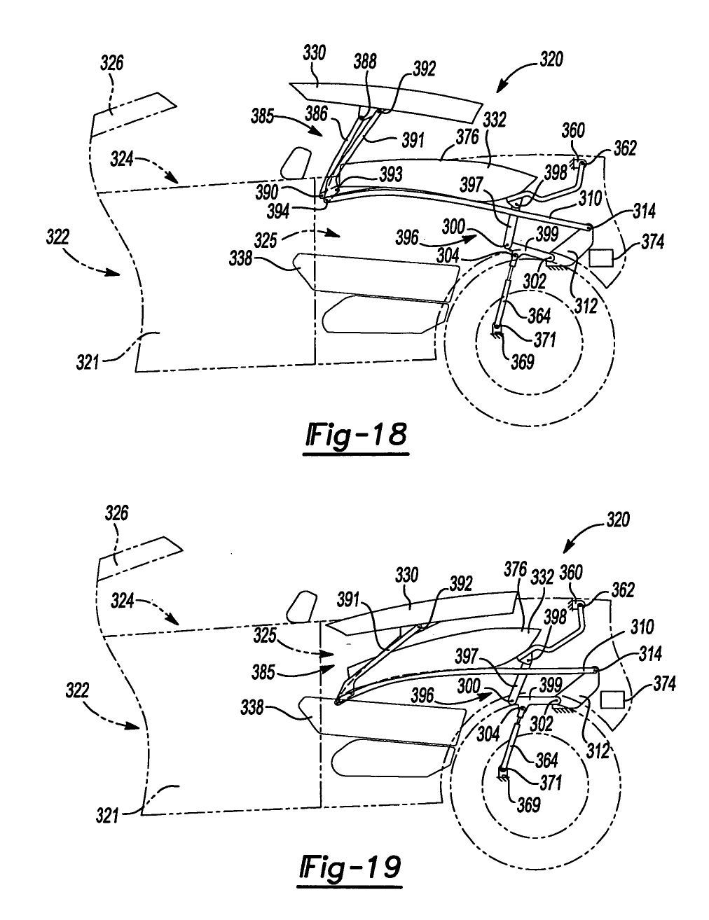

Referring now to FIGS. 16-19, a convertible top 320 according to the present teachings is shown on a vehicle 322. Convertible top 320 and vehicle 322 are similar to convertible top 220 and vehicle 222 discussed above and utilizes linkage assemblies and/or actuator(s) to move a front rigid panel 330 and a rear rigid panel 332 between a raised position, as shown in FIG. 16, through intermediate positions, such as those shown in FIGS. 17 and 18, to a stowed position, as shown in FIG. 19. Due to the similarities between convertible tops 220 and 320 and vehicles 222 and 322, the description of convertible top 320 and vehicle 322 may be limited to the differences with convertible top 220 and vehicle 222 and all of the details of convertible top 320 and vehicle 322 may not be discussed.

In convertible top 320, front panel 330 can be coupled to rear panel 332 with a front four-bar linkage assembly 385 similar to that used in convertible top 220. Front panel 330, first link 386, projection 389 and second link 391 form four-bar linkage assembly 385 which is defined by pivots 388, 390, 393, and 392. Linkage assembly 385 controls motion of front panel 330 relative to rear panel 332 and vehicle 322 during movement of convertible top 320 between the raised and stowed positions.

In convertible top 320, a front actuator is not utilized to drive movement of linkage assembly 385. Rather, a fixed length link 310 is utilized to control movement of linkage assembly 385 based on movement of rear panel 332 as driven by actuator 364. One end of link 310 can be pivotally coupled to an end of second link 391 at pivot 394 rearward of pivot 393. An opposite end of link 310 can be pivotally coupled to a fixed bracket 312 at pivot 314.

In convertible top 320, actuator 364 can cause movement of rear linkage assembly 396 which in turn drives movement of rear panel 332 about pivot 398 and moves convertible top 320 between the raised and stowed positions. Linkage assembly 396 includes first and second links 397, 399 which are pivotally coupled together at pivot 300. First link 397 is also pivotally coupled to rear panel 332 at pivot 398 while second link 399 is also pivotally coupled to bracket 312 at pivot 302. If desired, second link 399 can be pivotally coupled to a separate and discrete bracket. One end of actuator 364 is pivotally coupled to second link 399 at pivot 304 while the opposite end is pivotally coupled to fixed bracket 369 at pivot 371. Actuator 364 can extend and retract in response to an input from control unit 374 to cause movement of linkage assembly 396 and drive rotation of rear panel 332 relative to vehicle 322 about pivot 362. Rear actuator 364 can be a fluidic actuator, such as a hydraulic or pneumatic actuator.

In operation, convertible top 320 is moved from the raised position depicted in FIG. 16 through intermediate positions, such as the ones depicted in FIGS. 17 and 18, to the stowed position depicted in FIG. 19 by first unlatching front panel 330 from front header 326. An operator engages a switch (not shown) located in passenger compartment 324. The switch is electrically connected to control unit 374 to control the operation of convertible top 320. The positioning of seatbacks 338 and the retractable windows can be done in the same manner discussed above with reference to operation of convertible top 20.

Regardless of the system(s) employed to control seatbacks 338 and the retractable windows, once seatbacks 338 and the retractable windows are in the appropriate positions to allow the desired movement of convertible top 320, control unit 374 sends a signal to operate actuator 364. Control unit 374 causes actuator 364 to begin retracting which drives linkage assembly 396 and pulls rear panel 332 downwardly into rear passenger compartment 325 as rear panel 332 rotates counterclockwise about pivot 362. This rotation of rear panel 332 causes rear portion 358 of rear panel 332 to immediately begin falling below the beltline of vehicle 322 and into rear passenger compartment 325. As a result of this movement, the need for a moveable tonneau cover can be avoided.

The counterclockwise rotation of rear panel 323 causes link 310 to rotate counterclockwise about pivot 314 and drive movement of linkage assembly 385. The movement of link 310 causes linkage assembly 385 to drive movement of front panel 330 relative to rear panel 332. Front panel 330 moves upwardly and rearwardly relative to rear panel 332 and eventually begins to move downwardly relative to rear panel 332 with the interior surface of front panel 330 facing the exterior surface 376 of rear panel 332. This relative movement continues until front panel and rear panels 330, 332 have moved to the stowed position in rear passenger compartment 225, as shown in FIG. 19. Once convertible top 320 is in the fully stowed position, control unit 374 causes actuator 364 to cease retracting. To move convertible top 320 from the stowed position to the raised position, the opposite procedure can be performed.

In convertible top 320, link 310 enables convertible top 320 to be driven between the raised and stowed positions through the use of a single actuator 364 on each side of vehicle 322. In convertible top 320, movement of front panel 330 relative to rear panel 332 occurs simultaneously with the rotational movement of rear panel 332 about pivot 362. Link 310 and its associated pivots 394, 314 are configured to avoid convertible top 320 from encroaching undesirably into front passenger compartment 324 during the raising and lower process.

The use of linkage assembly 396 can facilitate rotation of rear panel 332 about pivot 362. Additionally, linkage assembly 396 may also provide for packaging efficiency and may reduce the packaging space required to drive movement of convertible top 320 between the raised and stowed positions. The use of linkage assembly 396 can also facilitate the holding of convertible top 320 in the raised position by driving linkage assembly 396 into an over-center position to provide a locking function, if desired. Specifically, a stop can be used to limit movement of convertible top 320 into the fully raised position and linkage assembly 396 can be configured to take an over-center position when convertible top 320 is in the fully raised position and engaged with the stop. As a result, the dynamic system of linkage assembly 396, actuator 364, rear panel 332 and the stop is driven to ground and becomes a static structure that can take the loading off of actuator 364.

In the stowed position, the interior surface of front panel 330 faces the exterior surface 376 of rear panel 332. In the stowed position, the exterior surface 378 of front panel 330 can provide an aesthetically pleasing and sculpted appearance for vehicle 322 yielding a sporty aerodynamic look of a roadster. Additionally, exterior surface 378 of front panel 330 when in the retracted position acts as a cover for the stored convertible top 320. As shown in FIG. 19, the convertible vehicle 322 is thereby converted from a 4-passenger coupe to a 2-passenger roadster by moving convertible top 320 from the raised or operative position to the stowed or retracted position.

Thus, in a vehicle having a convertible top according to the present teachings, a dedicated storage space is unnecessary since the rear passenger compartment is utilized to store the convertible top. With the rear passenger compartment serving as the storage space, the rear storage compartment of the vehicle may remain intact with the same storage capacity regardless of the convertible top being in the raised or retracted position. Despite the loss of the rear passenger compartment during operation in the convertible mode, the present teachings still provide for front and rear passenger seating with the convertible top in a raised operative position.

It should be appreciated that the convertible tops of the present teachings also include numerous seals (not shown) to provide a weather-tight enclosure for the passenger compartments of the vehicle. For example, front and rear panels can form a weather-tight seal therebetween along with forming weather-tight seals against the front header, the retractable windows and along the tonneau cover or a fixed rear panel or decklid of the vehicle.

Convertible tops 120, 120′, 220, 220′, and 320 can advantageously avoid the use of a moveable tonneau cover or other moveable rain trough device. Specifically, in these convertible tops 120, 120′, 220, 220′, and 320 the initial movement of the rear panel is downward toward the associated rear passenger space. This initial downward movement allows a rain trough along the back edge of the associated rear panel to be stationary. The use of a stationary rain trough facilitates the attachment of a retractable roof to a vehicle and can result in a lower cost vehicle. In particular, a tulip panel or an extension on the front edge of a decklid can be utilized to provide a weather-tight seal against the rear portion of the rear panel and allow the rain to be routed to an appropriate location. This can advantageously allow the use of a same decklid when a vehicle is produced in both non-convertible and convertible versions. To facilitate the motion of the decklid, a simple four-bar mechanism that allows the front edge of the decklid to move out of the way of the rear panel can allow the decklid to be used to access a rear storage area with the convertible roof in the raised or stowed position.

The preceding description of the present teachings is merely exemplary in nature and, thus, variations that do not depart from the gist of the teachings are intended to be within the scope of the teachings. While the rear passenger seats are described as being folded by moving the seatbacks forwardly toward the bottom cushions, it should be appreciated that other ways of folding rear passenger seats can be employed. For example, the bottom cushions can be rotated forwardly and the seatbacks then rotated forwardly. Additionally, while two rigid panels are shown, it should be appreciated that additional rigid panels may be employed, if desired, although all the advantages of the present invention may not be realized.

Moreover, while the convertible tops are shown and described as being automatically actuated, it should be appreciated that manually operated versions can be employed. Such manually operated convertible tops can use gas cylinder or other biasing devices to facilitate the movement of the roof panels between the raised and stowed positions. Furthermore, while the actuators to drive the movement of the convertible tops are shown as being linear actuators (high or low pressure), it should be appreciated that rotary actuators can be utilized to drive rotation of a link or panel about a pivot. Such rotary actuators can include a linear hydraulic cylinder that drives a rack along a pinion thereby converting the linear motion of the hydraulic cylinder (and rack) to a rotary motion of a link or panel about a pivot. Another suitable rotary actuator includes those disclosed in U.S. Pat. No. 5,772,274, entitled “Motorized Drive System for a Convertible Roof of an Automotive Vehicle” issued to Tokarz, the disclosure of which is incorporated by reference herein. Additionally, other electric motors or other suitable automatically-powered transfer mechanisms may be employed to drive movement of the convertible top. The selection of these actuators can be based upon the packaging space available to package the drive systems for the convertible top in the particular vehicle architecture upon which the convertible top is to be employed.

It should also be appreciated that the various brackets shown and described can be combined into fewer brackets, if desired and depending on the architecture of the particular vehicle on which a convertible top according to the present teachings is to be utilized. Moreover, other materials and dimensions can be substituted for those disclosed. Additionally, while convertible top 120 is shown as having a quarter window 133 fixed to rear panel 132 while the other convertible tops do not, it should be appreciated that a fixed quarter window can be employed with these other convertible top teachings. In particular, a fixed quarter panel window can be attached to the rear panel to facilitate the convertible top. In particular, the use of a fixed quarter window avoids the cost of providing a separate retraction mechanism for the quarter window. Such capability can depend upon the architecture of the vehicle upon which the associated convertible top is to be employed. The convertible tops disclosed may also include additional members or linkages. One or more of the panels can be fabric covered, if desired. A soft-top roof may also be used with the present teachings although various advantages of the present teachings may not be achieved.

Thus, while it is apparent that the present teachings are well calculated to provide the advantageous and features above stated, it will be appreciated that the present teachings are susceptible to modification, variation and change without departing from the proper scope or fair meaning of the subsequent claims.

What is claimed is:

1. A convertible top for an automotive vehicle comprising at least two rigid panels coupled together and moveable from a raised operative position covering front and rear passenger seating areas to a retracted position within said rear passenger seating area, wherein a rearmost one of said panels retracts downwardly into said rear passenger seating area and a forward one of said panels moves rearwardly to a position above said rearmost panel simultaneously with retraction of said rearmost panel into said rear passenger seating area.

2. The convertible top of claim 1, wherein said rearmost panel pivots downwardly and forwardly into said rear passenger seating area.

3. The convertible top of claim 1, wherein said front panel is coupled to said rearmost panel with a linkage assembly.

4. The convertible top of claim 3, wherein said linkage assembly is coupled to a fixed length link which is pivotally coupled to the vehicle at a fixed pivot.

5. The convertible top of claim 3, wherein said linkage assembly is a 4-bar linkage assembly.

6. The convertible top of claim 3, wherein said rearmost panel is pivotally coupled to the vehicle with a four-bar linkage assembly.

7. The convertible top of claim 1, wherein an exterior surface of said front panel faces upwardly and said front panel covers a majority of said rearmost panel and a majority of said rear passenger seating area when in said retracted position.

8. The convertible top of claim 1, wherein said rearmost panel is pivotally connected to the vehicle with a goose-neck hinge.

9. The convertible top of claim 1, wherein a rear edge of said rearmost panel is below a beltline of the vehicle when in said retracted position.

10. The convertible top of claim 1, wherein an entirety of said rearmost panel is below a beltline of the vehicle when in said retracted position.

11. A convertible top for an automotive vehicle comprising at least two rigid panels coupled together and moveable from a raised operative position covering front and rear passenger seating areas to a retracted position within said rear passenger seating area, wherein a rearmost one of said panels rotates forwardly into a storage area with a rear edge of said rearmost panel dropping down into said storage area and residing below a beltline of the vehicle when in said retracted position.

12. The convertible top of claim 11, wherein said rear passenger seating area forms at least a majority portion of said storage area and said rearmost panel rotates forwardly into said rear passenger seating area with said rear edge of said rearmost panel dropping down into said storage area and residing below a beltline of the vehicle when in said retracted position.

13. The convertible top of claim 11, wherein an entirety of said rearmost panel drops down and is below a beltline of the vehicle when in said retracted position.

14. The convertible top of claim 11, wherein a forward one of said panels is above and covers a majority of said rearmost panel when in said retracted position.

15. The convertible top of claim 11, wherein an exterior surface of said rearmost panel faces upwardly when in said retracted position.

16. The convertible top of claim 11, wherein said rearmost panel occupies said rear passenger area when in said retracted position.

17. The convertible top of claim 11, wherein said rearmost panel is pivotally coupled to the vehicle with a goose-neck hinge that extends rearwardly from said rearmost panel.

18. A convertible top for an automotive vehicle comprising:
at least two rigid panels coupled together and moveable from a raised operative position covering front and rear passenger seating areas to a retracted position within said rear passenger seating area;
a rearmost one of said panels pivoting rearwardly into said rear passenger seating area when moving from said raised position to said retracted position;
a forward one of said panels directly pivotally coupled to said rearmost panel and rotating forwardly relative to said rearmost panel when moving from said raised position to said retracted position; and
a fixed length link pivotally coupled to said forward panel and to the vehicle, said link limiting movement of said forward panel relative to the vehicle,
wherein said forward panel covers a majority of said rearmost panel and a majority of said rear passenger seating area when in said retracted position.

19. The convertible top of claim 18, further comprising a hinge directly pivotally coupling said forward panel to said rearmost panel.

20. The convertible top of claim 18, wherein said rearmost panel moves simultaneously with retraction of said rearmost panel into said rear passenger seating area.

21. The convertible top of claim 18, wherein said rearmost panel includes a side quarter window.

22. The convertible top of claim 18, wherein a single set of actuators drives movement of said panels between said raised and retracted positions.

23. A convertible top for an automotive vehicle comprising at least two rigid panels coupled together and moveable from a raised operative position covering front and rear passenger seating areas to a retracted position within a storage area, a rearmost one of said panels moving to a generally vertical position during movement between said raised and retracted positions and rotating forwardly into said storage area when moving to said retracted position.

24. The convertible top of claim 23, wherein said panels self-cover said storage area.

25. The convertible top of claim 23, wherein said rear seat passenger area forms a majority portion of said storage area.

26. The convertible top of claim 25, wherein said rearmost panel covers a majority portion of said rear seat passenger area when in said retracted position.

27. The convertible top of claim 23, wherein said rearmost panel initially rotates rearwardly to said generally vertical position and then rotates forwardly into said rear passenger seating area during movement from said raised position to said retracted position.

28. The convertible top of claim 23, wherein a forward one of said panels is in a generally vertical position when said rearmost panel is in a generally vertical position.

29. The convertible top of claim 28, wherein interior surfaces of said rearmost and forward panels face one another when in said generally vertical positions.

30. The convertible top of claim 29, wherein said forward panel is directly pivotally coupled to said rearmost panel.

31. The convertible top of claim 23, wherein an exterior surface of said rearmost panel covers a majority portion of said rear passenger seating area when in said retracted position.

32. The convertible top of claim 23, wherein said rearmost panel is directly pivotally coupled to the vehicle.

33. The convertible top of claim 23, wherein a first actuator drives movement of said rearmost panel and a second actuator drives movement of a front panel relative to said rearmost panel.

34. A convertible top for an automotive vehicle comprising at least two rigid panels coupled together and moveable from a raised operative position covering front and rear passenger seating areas to a retracted position within said rear passenger seating area, an exterior surface of a rearmost one of said panels faces upwardly when in said retracted position and an interior surface of a forward one of said panels faces an interior surface of said rearmost panel when in said retracted position.

35. The convertible top of claim 34, wherein an exterior surface of said rearmost panel covers a majority of said forward panel when in said retracted position.

36. The convertible top of claim 34, wherein a front edge of said rearmost panel is disposed immediately behind a front passenger seat of the vehicle when in said retracted position.

37. The convertible top of claim 34, wherein rear passenger seats in said rear passenger seating area are folded when said panels are in said retracted position.

38. A convertible top for an automotive vehicle comprising at least two rigid panels coupled together and moveable from a raised operative position covering front and rear passenger seating areas to a retracted position within said rear passenger seating area, a forward one of said panels moving to a position above a rearmost one of said panels while said rearmost panel remains generally in said raised position, said forward panel remaining in said position above said rearmost panel as said rearmost panel moves from said raised position to said retracted position.

39. The convertible top of claim 38, wherein an interior surface of said forward panel faces an exterior surface of said rearmost panel when said forward panel is in said position above said rearmost panel.

40. The convertible top of claim 38, wherein an exterior surface of said rearmost panel faces upwardly when in said retracted position.

41. The convertible top of claim 38, wherein said front panel covers a majority portion of said rearmost panel with an exterior surface of said front panel facing upwardly when said front and rearmost panels are in said retracted position.

42. The convertible top of claim 38, wherein said rearmost panel rotates forwardly into said rear passenger seating area when moving from said raised position to said retracted position.

43. The convertible top of claim 38, wherein said front panel is coupled to said rearmost panel with a 4-bar linkage assembly.

44. The convertible top of claim 38, wherein a first actuator drives movement of said front panel relative to said rearmost panel and a second actuator drives movement of said rearmost panel between said raised and retracted positions.

45. The convertible top of claim 38, wherein said front panel covers a majority portion of said rear passenger seating area when said panels are in said retracted position.

46. A method of operating a convertible top having at least two rigid panels coupled together and moveable from a raised operative position covering front and rear passenger seating areas to a retracted position within a storage area, the method comprising:
moving a rearmost one of the panels to a generally vertical position during movement of the convertible top between the raised and retracted positions; and
rotating said rearmost panel forwardly into the storage area when moving to the retracted position.

47. The method of claim 46, further comprising initially rotating said rearmost panel to said generally vertical position and then rotating said rearmost panel forwardly into said storage area during movement from the raised position to the retracted position.

48. The method of claim 46, further comprising moving a forward one of the panels to a generally vertical position such that both of said forward and rearmost panels are generally vertically positioned simultaneously.

49. The method of claim 48, wherein interior surfaces of said rearmost and forward panels face one another when in said generally vertical position.

50. The method of claim 46, further comprising moving the panels into a majority portion of the rear passenger seating area when moving to the retracted position.

51. The method of claim 46, further comprising self-covering the storage area with at least one of the panels when in the retracted position.
